(19) United States
(12) Patent Application Publication
(10) Pub. No.: US 2014/0361989 A1
(43) Pub. Date: Dec. 11, 2014

(54) Method and Device for Operating Functions in a Vehicle Using Gestures Performed in Three-Dimensional Space, and Related Computer Program Product

(71) Applicant: Daimler AG, Stuttgart (DE)

(72) Inventors: Volker Entenmann, Affalterbach (DE); Tingting Zhang-xu, Sindelfingen (DE)

(73) Assignee: Daimler AG, Stuttgart (DE)

(21) Appl. No.: 14/371,090

(22) PCT Filed: Dec. 8, 2012
(86) PCT No.: PCT/EP2012/005080

§ 371 Date: Jul. 8, 2014

(30) Foreign Application Priority Data
Jan. 10, 2012 (EP) 10 2012 000 263.7

(51) Int. Cl. G06F 3/01; G06K 9/00; G06F 3/00

(52) U.S. Cl. CPC G06F 3/017; G06F 3/005; G06K 9/00355
USPC 345/156

(57) ABSTRACT

A method to control functions in a vehicle using gestures carried out in three-dimensional space. When it is determined that a first gesture carried out in three-dimensional space is detected using an image-based detection procedure it is determined whether the first gesture is a gesture allocated to an activation of an operation of a function. If it is that the detected first gesture is the gesture allocated to the activation of the function, then the function is activated. Next, a second a second gesture carried out in three-dimensional space is detected using the image-based detection procedure and it is determined whether the detected second gesture is a gesture allocated to the operation of the function. If it is determined that the second gesture has been detected, an operation of the function is performed.

### CROSS-REFERENCE TO RELATED APPLICATIONS

This application is related to PCT Application No. PCT/EP2012/005130, filed Dec. 8, 2012, a National Stage application of which is U.S. application Ser. No. _____ (Attorney Docket No. 095309.66678US), and PCT Application No. PCT/EP2012/005081, filed Dec. 8, 2012, a National Stage application of which is U.S. application Ser. No. _____ (Attorney Docket No. 095309.66616US).

### BACKGROUND AND SUMMARY OF THE INVENTION

Exemplary embodiments of the present invention relate to a method and device to control functions in a vehicle using gestures carried out in three-dimensional space as well as a relevant computer program product.

U.S. patent document U.S. 2008/0065291 A1 discloses a method and a device to control functions in a vehicle using gestures carried out in three-dimensional space, in which it is determined whether a gesture carried out in three-dimensional space is detected by means of an image-based detection procedure or not, it is determined whether the detected gesture is a gesture allocated to an operation of a function or not and the function is operated in the case that it is determined that the detected gesture is the gesture allocated to the operation of the function.

As it is directly determined whether a detected gesture is a gesture allocated to the operation of a function or not, a movement, for example, of a finger or a hand of a user, which is carried out in a detection region of an image-based gesture detection device and is not intended to operate a function, can be determined erroneously as a gesture allocated to the operation of the function. Consequently, in this case, the function is carried out erroneously or unintentionally.

Exemplary embodiments of the present invention are directed to a method, a device, and a relevant computer program product, which allow a gesture-based control of functions in a vehicle in a simple and reliable way.

According to a first aspect, a method to control functions in a vehicle using gestures carried out in three-dimensional space features a) a determination as to whether a first gesture carried out in three-dimensional space is detected or not by means of an image-based detection procedure, b) a determination as to whether the first gesture is a gesture allocated to an activation of an operation of a function or not, in the case that it is determined that the first gesture has been detected, c) an activation of the operation of the function, in the case that it is determined that the detected first gesture is the gesture allocated to the activation of the operation of the function, d) a determination as to whether a second gesture carried out in three-dimensional space is detected or not by means of an image-based detection procedure, e) a determination as to whether the detected second gesture is a gesture allocated to the operation of the function or not, in the case that it is determined that the second gesture has been detected, and f) an operation of the function, in the case that it is determined that the detected first gesture is the gesture allocated to the activation of the operation of the function and in the case that it is determined that the detected second gesture is the gestured allocated to the operation of the function.

According to one embodiment, steps d) to f) are carried out directly one after the other after the repeated implementation of steps a) to c).

According to a further embodiment, it is determined in step b) that the detected first gesture is the gesture allocated to the activation of the operation of the function in the case that the detected first gesture is a first predetermined gesture, which is static for a first predetermined amount of time in an interaction region in three-dimensional space.

According to a further embodiment, in step c) a display element depicting the activation of the function is displayed.

According to a further embodiment, the display element depicting the activation of the function is no longer displayed on the display unit after a fourth predetermined amount of time in which no gesture is detected.

According to a further embodiment, it is determined in step e) that the detected second gesture is the gesture allocated to the operation of the function in the case that the detected second gesture is a second predetermined gesture, which is dynamic in the interaction region in three-dimensional space.

According to a further embodiment, the interaction region is set to be smaller than a maximum detection region of the image-based detection procedure.

According to a further embodiment, the interaction region is set to be free from obstructions.

According to a further embodiment, the interaction region is adapted dynamically depending on context.

According to a further embodiment, the image-based detection procedure is camera-based and a position of an object carrying out a gesture in three-dimensional space is detected.

According to a second aspect, a device to control functions in a vehicle using gestures carried out in three-dimensional space has equipment which is designed to carry out the method described above or the embodiments thereof.

According to a third aspect, a computer program product to control functions in a vehicle using gestures carried out in three-dimensional space is designed to carry out the method described above or the embodiments thereof directly in combination with a computer or a computer system or indirectly after a predetermined routine.

The first to third aspects and the embodiments thereof prevent a movement, for example, of a finger or a hand of a user, which is not intended to operate a function, from being determined as the gesture allocated to the operation of the function by requiring that a gesture allocated to an activation of an operation of a function, by means of which the operation of the function is activated, must be detected before a detection of the gesture allocated to the operation of the function.

### BRIEF DESCRIPTION OF THE DRAWING FIGURES

The present invention is explained in more detail below by means of exemplary embodiments with reference to the enclosed drawing.

In the drawing is shown:

FIG. 1 a schematic depiction of a basic structure of a display unit and a detection concept according to an exemplary embodiment of the present invention.

FIG. 2 a further schematic depiction of the basic structure of the display unit and the detection concept according to the exemplary embodiment of the present invention.

FIG. 3 a schematic depiction of the basic structure of the display unit and an installation location of a detection device in an overhead control unit according to the exemplary embodiment of the present invention.

FIG. 4 a schematic depiction of the basic structure of the display unit and an installation location of a detection device in an inner mirror according to the exemplary embodiment of the present invention; and

FIG. 5 a flow diagram of a method to operate functions in a vehicle using gestures carried out in three-dimensional space according to the exemplary embodiment of the present invention.

### DETAILED DESCRIPTION

The description of one exemplary embodiment of the present invention occurs below.

It is to be noted that, below, it is assumed that a display unit is a preferably central display of a vehicle, preferably a motor vehicle, and a method to control functions depicted on the display unit using gestures carried out in three-dimensional space in the vehicle is carried out.

Furthermore, a gesture described below is a gesture carried out in three-dimensional space by a user of the vehicle by means of a hand or a finger of the user, without touching a display, such as, for example, a touch screen, or a control element, such as, for example, a touch pad.

The image-based capturing device described below can be any expedient camera, which is able to detect a gesture in three-dimensional space, such as, for example, a depth camera, a camera having structured light, a stereo camera, a camera based on time-of-flight technology or an infra-red camera combined with a mono camera. A plurality of any combinations of such cameras is possible. An infra-red camera combined with a mono-camera improves a detection capability, as a mono camera having a high image resolution additionally provides intensity information, which offers advantages during a background segmentation, and a mono camera is impervious to extraneous light.

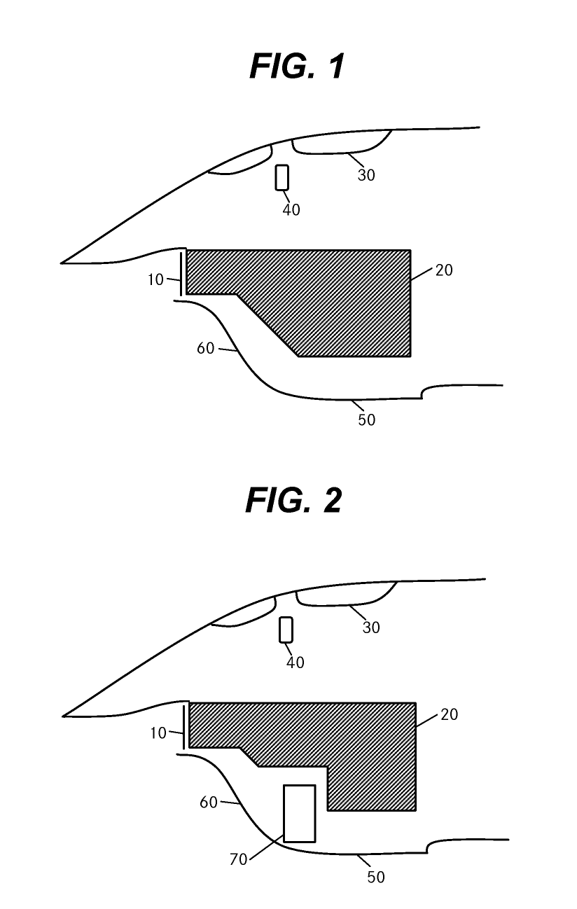

FIG. 1 shows a schematic depiction of a basic structure of a display unit and a detection concept according to an exemplary embodiment of the present invention.

In FIG. 1, the reference numeral 10 refers to a display unit of a vehicle, the reference numeral 20 refers to a valid detection region of an image-based detection device, the reference numeral 30 refers to an overhead control unit of the vehicle, the reference numeral 40 refers to an inner mirror of the vehicle, the reference numeral 50 refers to a central console of the vehicle and the reference numeral 60 refers to a dome of the vehicle.

The basic control concept is that a gesture operation to control functions by means of a gesture carried out by a hand or a finger of a user in the valid detection region 20 is carried out in three-dimensional space in the case that the gesture carried out is detected as a predetermined gesture in the detection region 20 by means of the image-based detection device.

The valid detection region 20 is determined by an image-based detection device, which is able to detect a three-dimensional position of the hand or the fingers of the user in three-dimensional space. Preferably, the image-based detection device is a depth camera integrated into the vehicle.

The image-based detection device must be integrated such that a gesture operation is allowed by a relaxed hand and/or arm position of the user at any position in the region above the dome 60 and the central console 50 of the vehicle. Thus a valid detection region is limited from above by an upper edge of the display unit 10 and from below by a minimum distance to the dome 60 and the central console 50.

A gesture operation is activated in the case that a first gesture is detected in the valid detection region 20, which is a first predetermined gesture. The first predetermined gesture is a static gesture which is carried out by moving the hand or the finger of the user into the valid detection region 20 and subsequently temporarily leaving the hand or the finger of the user in the valid detection region 20 for a first predetermined amount of time.

The gesture operation is deactivated by moving the hand or the finger of the user out of the valid detection region. A laying of the hand or the arm of the user on the central console 20 and a control of components of the vehicle is carried out under the valid detection region 20, whereby a gesture operation is not activated.

A static gesture is not carried out in the case of a gesticulation in the vehicle and in the case of moving the hand or the finger of the user to a control element, whereby a gesture operation is not activated.

FIG. 2 shows a further schematic depiction of the basic structure of the display unit and the detection concept according to the exemplary embodiment of the present invention.

In FIG. 2, the same reference numerals refer to the same elements as in FIG. 1 and the reference numeral 70 refers to an item present in or on the central console 50 as an obstructive object, such as, for example, a drink container in a cup holder.

The statements made above with regard to FIG. 1 likewise apply for FIG. 2.

A lower boundary of the valid detection region 20 is dynamically adapted to the item 70. Such a context-dependent adaptation of the valid detection region as an interaction region is carried out such that a depth contour of the valid detection region is carried out by means of depth information of the image-based detection device, such as, for example, the depth camera, in real time in the case of a detection of a gesture. This means that a valid gesture must be carried out above the item 70.

An arrangement of the image-based detection device in an overhead region of the vehicle leads to the following advantages: No sunlight shines into a lens of the image-based detection device. A complete detection region is also covered in an adjacent region of the display unit 10 as a valid detection region 20. There is a high image resolution in the main interaction directions to the left, to the right, to the front and to the back of the gesture operation. The image-based detection device is made up of a normal visual range of driver and passenger. Overhead components can be easily standardized for different series with few design variations. Few requirements for a detection distance are required.

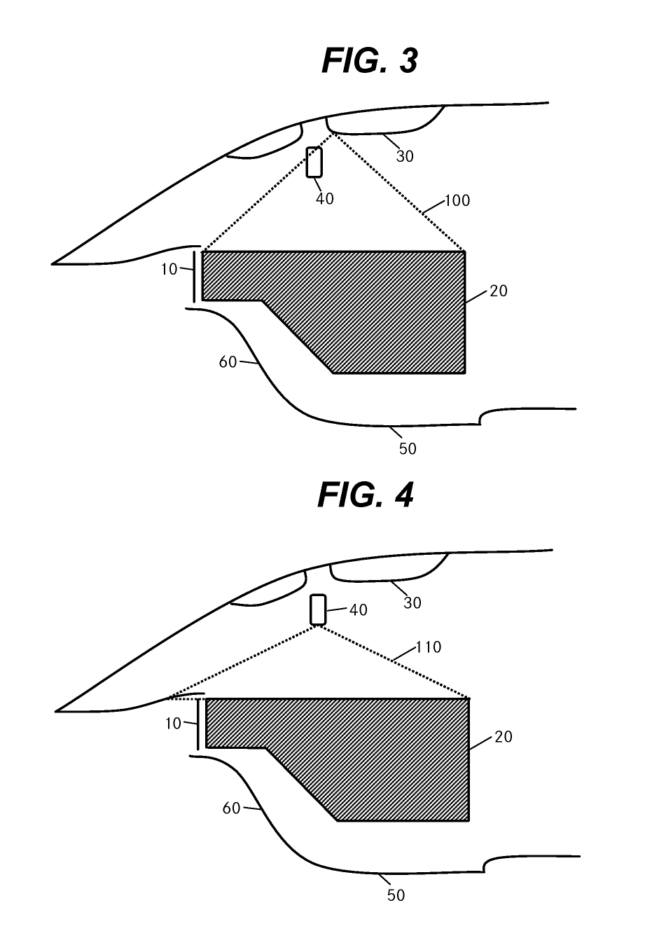

With respect to FIG. 3 and FIG. 4, two possible installation locations for the image-based detection device in the overhead region of the vehicle are illustrated.

FIG. 3 shows a schematic depiction of the basic structure of the display unit and an installation location of the detection device in the overhead control unit according to the exemplary embodiment of the present invention.

In FIG. 3 the same reference numerals refer to the same elements as in FIG. 1 and FIG. 2 and the reference numeral 100 refers to a maximum detection angle of an image-based detection device integrated into the overhead control unit 30 of the vehicle.

The statements made above with regard to FIG. 1 and FIG. 2 likewise apply for FIG. 3.

As can be seen in FIG. 3, the complete valid detection region 20 is covered with the image-based detection device integrated into the overhead control unit 30. A further advantage of the image-based detection device integrated into the overhead control unit 30 is that the greatest possible vertical distance to the valid detection region 20 is achieved.

FIG. 4 shows a schematic depiction of the basic structure of the display unit and an installation location of a detection device in an inner mirror according to the exemplary embodiment of the present invention.

In FIG. 4, the same reference numerals refer to the same elements as in FIG. 1 and FIG. 2 and the reference numeral 110 refers to a maximum detection angle of an image-based detection device integrated into the inner mirror 40 of the vehicle.

The statements made above with regard to FIG. 1 and FIG. 2 likewise apply for FIG. 4.

As can be seen in FIG. 4, the complete valid detection region 20 is covered with the image-based detection device integrated into the overhead control unit 30. In order to compensate for a changing alignment of the image-based detection device due to an adjustment of the inner mirror 40, an alignment offset of the image-based detection device is corrected by means of a contour of the central console 50 in order to carry out a positional calibration.

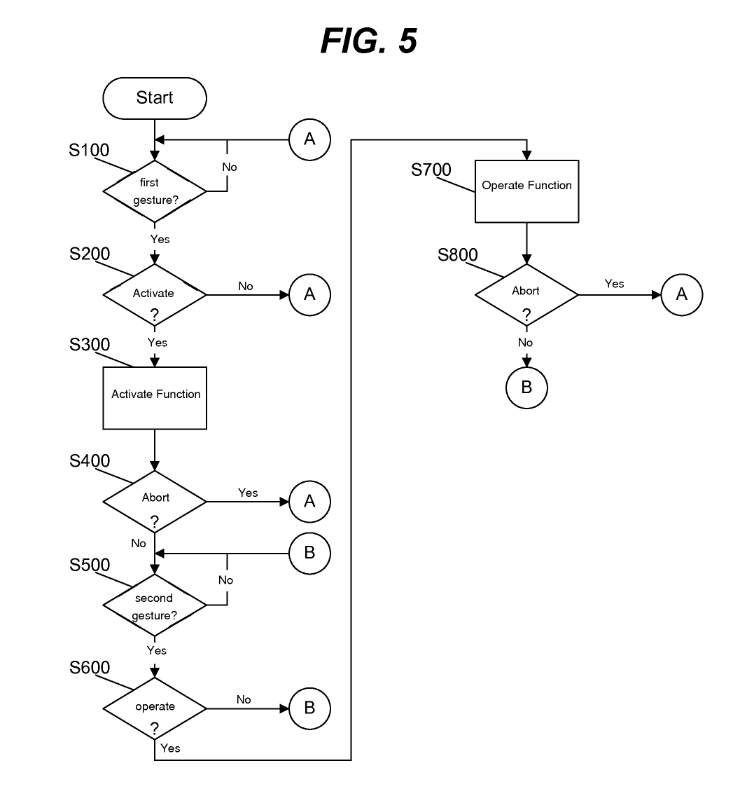

FIG. 5 shows a flow diagram of a method to control functions in a vehicle using gestures carried out in three-dimensional space according to the exemplary embodiment of the present invention.

It is to be noted that a process flow of the flow diagram in FIG. 5 is switched on, for example, after an initialization point, such as, for example, after switching on an ignition of the vehicle, and is carried out in repeating cycles until an end point, such as, for example, a switching-off of the ignition of the vehicle, is reached. Alternatively, the initialization point can, for example, be the point in time of starting a motor of the vehicle and/or the end point can be the point in time of switching off the motor of the vehicle. Other initialization points and end points are likewise possible according to the present application.

A distinction can be made as to whether a gesture is carried out by a driver or by a passenger, which is particularly advantageous in a so-called split view display, which is able to display different pieces of information to the driver and the passenger simultaneously. Likewise, the distinction as to whether a gesture is carried out by a driver or by a passenger is advantageous with regard to an ergonomic control by the driver or the passenger.

Below, it is assumed that the detected gesture can be both a gesture carried out by the driver and a gesture carried out by the passenger.

Furthermore, it is to be noted that in the case of the distinction described above between a gesture of the driver and of the passenger, the method of the flow diagram in FIG. 5 is carried out both for the driver's side and for the passenger's side. The process sequence shown in FIG. 5 can be carried out expediently, for example, in parallel, in series or in a connected manner for the driver side and the passenger side.

In step S100, it is determined whether a first gesture is detected or not. In the case that the first gesture is not detected (“No” in step S100), the process sequence returns to step S100. In the case that the first gesture is detected (“Yes” in step S100), the process sequence advances to step S200.

In step S200, it is determined whether the detected first gesture is a gesture allocated to an activation of an operation of a function or not. In the case that the first gesture is not a gesture allocated to the activation of the operation of the function (“No” in step S200), the process sequence returns to step S100. In the case that the first gesture is a gesture allocated to the activation of the operation of the function (“Yes” in step S200), the process sequence advances to step S300.

The gesture allocated to the activation of the operation of the function is a first predetermined gesture, which is static for a first predetermined amount of time in an interaction region in three-dimensional space. The first predetermined gesture is detected, as has been described above with reference to FIGS. 1 to 3. The interaction region corresponds to the valid detection region described above.

In step S300, the operation of the function is activated. After step S300, the process sequence advances to step S400.

On activation of the operation of the function, a display element, which displays the activation of the function, is displayed on the display unit 10.

In step S400, it is determined whether a predetermined abort condition is fulfilled or not. In the case that the predetermined abort condition is fulfilled (“Yes” in step S400), the process sequence returns to step S100. In the case that the abort condition is not fulfilled (“No” in step S400), the process sequence advances to step S500.

The predetermined abort condition can, for example, be that no gesture has been detected for a fourth predetermined amount of time. In the case that the predetermined abort condition in step S400 is fulfilled, the display element depicting the activation of the function is no longer displayed on the display unit.

In step S500, it is determined whether a second gesture is detected or not. In the case that the second gesture is not detected (“No” in step S500), the process sequence returns to step S500. In the case that the second gesture is detected (“Yes” in step S500), the process sequence advances to step S600.

In step S600, it is determined whether the detected second gesture is a gesture allocated to an operation of the function or not. In the case that the second gesture is not a gesture allocated to the operation of the function (“No” in step S600), the process sequence returns to step S500. In the case that the second gesture is a gesture allocated to the operation of the function (“Yes” in step S600), the process sequence advances to step S700.

The gesture allocated to the operation of the function is a second predetermined gesture, which is dynamic in the interaction region in three-dimensional space.

In step S700, the function is operated. After step S700, the process sequence advances to step S800.

During operation of the function, a display element, which displays the operation of the function, can be displayed on the display unit.

In step S800, it is determined whether a predetermined abort condition is fulfilled or not. In the case that the predetermined abort condition is fulfilled (“Yes” in step S800), the process sequence returns to step S100. In the case that the abort condition is not fulfilled (“No” in step S800), the process sequence returns to step S500.

The predetermined abort condition can, for example, be that no gesture has been detected for the fourth predetermined amount of time. In the case that the predetermined abort condition in step S800 is fulfilled, the display element depicting the operation of the function is no longer displayed on the display unit.

The method described above can be carried out by means of equipment, which forms a device to control functions in a vehicle. A display unit is preferably a central display of the vehicle, preferably of a motor vehicle.

One application of the exemplary embodiment described above is, for example, a control or switching back and forth of a menu, such as, for example, of a main menu, of a radio station or of a medium, such as, for example, as CD, in a central telematics unit of the vehicle by means of gestures, i.e. hand or finger movements of the user, without touching a display, such as, for example, a touch screen, or a control element, such as, for example, a touch pad.

A learning process of the user can be supported by optical and/or aural feedback during a gesture control, whereby a blind control is enabled by the user after a learning phase of the user. The user can manually switch off such optical and/or aural feedback or such optical and/or aural feedback is switched off automatically after recognition of a correct gesture control by the user, for example for a predetermined amount of time.

Although specific installation locations for respective cameras are shown in FIGS. 3 and 4, respective cameras can be arranged in other expedient installation locations.

A simple and quick controllability is implemented by the image-based gesture control described above, which improves a control comfort, a control flexibility and control experience for the user and significantly increases the freedom of design for a vehicle interior.

The exemplary embodiment described above is able to be implemented as a computer program product, such as, for example, a storage medium, which is designed to carry out a method according to the exemplary embodiment above, interacting with a computer or several computers, i.e. computer systems, or other processing units. The computer program product can be designed such that the method is carried out only after the implementation of a predetermined routine, such as, for example, a set-up routine.

Although the present invention has been described above by means of an exemplary embodiment, it is to be understood that different embodiments and changes can be carried out without leaving the scope of the present invention, as is defined in the enclosed claims.

The disclosure of the drawing is exclusively referred to regarding further features and advantages of the present invention.

1-12. (canceled)

13. A method to control functions in a vehicle using gestures carried out in three-dimensional space, the method comprising:
a) determining whether a first gesture carried out in three-dimensional space is detected using an image-based detection procedure;
b) determining, if it is determined that the first gesture has been detected, whether the first gesture is a gesture allocated to an activation of an operation of a function;
c) activating operation of the function if it is determined that the detected first gesture is the gesture allocated to the activation of the operation of the function;
d) determining whether a second gesture carried out in three-dimensional space is detected by the image-based detection procedure;
e) determining, if it is determined that the second gesture has been detected, whether the detected second gesture is a gesture allocated to the operation of the function; and
f) operating the function if it is determined that the detected first gesture is the gesture allocated to the activation of the operation of the function and the detected second gesture is the gesture allocated to the operation of the function.

14. The method according to claim 13, wherein after performing steps a) to c), steps d) to f) are repeatedly performed directly one after the other.

15. The method according to claim 14, wherein it is determined in step b) that the detected first gesture is the gesture allocated to the activation of the operation of the function if the detected first gesture is static for a first predetermined amount of time in an interaction region in three-dimensional space.

16. The method according to claim 14, wherein in step c) a display element depicting the activation of the function is displayed.

17. The method according to claim 16, wherein the display element depicting the activation of the function is no longer displayed on the display unit after a fourth predetermined amount of time in which no gesture is detected.

18. The method according to claim 15, wherein it is determined in step e) that the detected second gesture is the gesture allocated to the operation of the function if the detected second gesture is dynamic in the interaction region in three-dimensional space.

19. The method according to claim 15, wherein the interaction region is smaller than a maximum detection region of the image-based detection procedure.

20. The method according to claim 15, wherein the interaction region is adjusted to be free from obstructions.

21. The method according to claim 15, wherein the interaction region is dynamically adapted based on context.

22. The method according to claim 13, wherein the image-based detection procedure is camera-based and a position of an object carrying out a gesture is detected in three-dimensional space.

23. A device to control functions in a vehicle using gestures carried out in three-dimensional space, wherein the device is configured to:
a) determine whether a first gesture carried out in three-dimensional space is detected using an image-based detection procedure;
b) determine, if it is determined that the first gesture has been detected, whether the first gesture is a gesture allocated to an activation of an operation of a function;
c) activate operation of the function if it is determined that the detected first gesture is the gesture allocated to the activation of the operation of the function;
d) determine whether a second gesture carried out in three-dimensional space is detected by the image-based detection procedure;
e) determine, if it is determined that the second gesture has been detected, whether the detected second gesture is a gesture allocated to the operation of the function; and
f) operate the function if it is determined that the detected first gesture is the gesture allocated to the activation of the operation of the function and the detected second gesture is the gesture allocated to the operation of the function.

24. A non-transitory computer-readable medium control functions displayed on a display unit of a vehicle using gestures carried out in three-dimensional space, wherein the computer-readable contains instructions, which when executed by a device, cause the device to:
a) determine whether a first gesture carried out in three-dimensional space is detected using an image-based detection procedure;
b) determine, if it is determined that the first gesture has been detected, whether the first gesture is a gesture allocated to an activation of an operation of a function;
c) activate operation of the function if it is determined that the detected first gesture is the gesture allocated to the activation of the operation of the function;
d) determine whether a second gesture carried out in three-dimensional space is detected by the image-based detection procedure;
e) determine, if it is determined that the second gesture has been detected, whether the detected second gesture is a gesture allocated to the operation of the function; and
f) operate the function if it is determined that the detected first gesture is the gesture allocated to the activation of the operation of the function and the detected second gesture is the gesture allocated to the operation of the function.
